(19) United States
(12) Patent Application Publication
(10) Pub. No.: US 2026/0073681 A1
(43) Pub. Date: Mar. 12, 2026

(54) APPARATUS AND METHOD FOR PROCESSING HIGH-ALTITUDE IMAGES

(71) Applicant: Near Space Labs, Inc., Brooklyn, NY (US)

(72) Inventors: Alexandra Moseguí Saladié, Manresa (ES); Ignasi Lluch i Cruz, Barcelona (ES); Albert Caubet, Barcelona (ES); Asa Jonas Ivry Block, Brooklyn, NY (US); Hripsime Matevosyan, Brooklyn, NY (US)

(21) Appl. No.: 19/323,809

(22) Filed: Sep. 9, 2025

Related U.S. Application Data
(60) Provisional application No. 63/693,843, filed on Sep. 12, 2024.

(51) Int. Cl. G06V 20/17; G06T 5/60

(52) U.S. Cl. CPC G06V 20/17; G06T 5/60

(57) ABSTRACT

In an embodiment, an apparatus for processing of high-altitude images is presented. An apparatus for processing high-altitude images may include a processor and a memory communicatively coupled to the processor. A memory may contain instructions configuring a processor to obtain image data. A processor may be configured to perform image processing on image data specific to an atmosphere associated with the image data. A processor may be configured to remove, through application of a machine learning model, obscure image data from processed image data to generate viable images. A processor may be configured to geolocate viable images based on obtained georeference data to generate geolocated image data. A processor may be configured to mosaic geolocated image data to produce a georeferenced map.

### CROSS-REFERENCE TO RELATED APPLICATION

This application claims priority to and the benefit of U.S. Provisional Patent Application No. 63/693,843, entitled “Systems and Methods for Processing High-altitude Images,” filed Sep. 12, 2024, the entire contents of which are incorporated herein by reference.

### TECHNICAL FIELD

The present disclosure relates to high-altitude image processing. In particular, the present disclosure relates to apparatuses and methods for processing of high-altitude images.

### BACKGROUND

To date, the methods for processing stratospheric images have been limited to adopting existing techniques from aerial or satellite systems. Those are ill-suited to stratosphere-based imaging due to the altitude involved, different atmospheric conditions, and the mechanics of imagery capture. For example, conventional aerial imaging from altitudes between 1,500 to 5,000 feet do not present significant color deviations, thus require minimal color processing. Also, satellite image processing typically requires full atmospheric calibration with Top of Atmosphere (ToA) reflectance measurements, which are not suited for a sensor flying at stratospheric altitudes.

### SUMMARY

In one aspect of the disclosed invention, an apparatus for processing of high-altitude images high-altitude includes a processor and a memory communicatively coupled to the processor. The memory contains instructions configuring the processor to obtain and process the image data, which may be specific to an atmospheric location associated with the image data. Further, the processor may be configured to remove, through the application of a specially-trained machine learning model, obfuscatory image data from the image data to generate clearer resulting images. The processor may also be configured to geolocate the resulting images based on georeference data to generate geolocated image data. The geolocated image data may then be stitched into a mosaic to produce a georeferenced map.

In some embodiments, image processing includes color correction. In some embodiments, obscure image data includes images with an amount of blur and the processor is configured to detect blur in the processed image data through application of the machine learning model and discard the detected blurred image data from further processing. In some embodiments, the obscure image data includes images with a cloud and the processor is configured to detect clouds in the processed image data through the machine learning model and discard image data of the processed image data based on the detected clouds from further processing. In some embodiments, the processor is configured to geolocate the image data through an indirect georeferencing method. In some embodiments, the processor is configured to geolocate the image data through global positioning system (GPS) coordinates. In some embodiments, the image data is obtained from an imaging device positioned within the stratosphere. In some embodiments, the atmospheric location is an altitude range of about 30,000 feet to about 100,000 feet. In some embodiments, the processor is configured to geolocate the image data through comparison of two or more viable images to each other. In some embodiments, the processor is configured to mosaic the geolocated image data by combining at least two overlapping images of the geolocated image data.

In another aspect, a computer-implemented method of processing high-altitude images includes obtaining image data and processing the image data based on a specific atmospheric location associated with the image data. The method includes applying a specially-trained machine learning model to remove obfuscatory image data from the image data to generate clearer resulting images. The viable images are then geolocated based on obtained georeference data to generate geolocated image data, which may be stitched into a mosaic of the resulting image data to produce a georeferenced map.

In some embodiments, the imaging process comprises color correcting the image data. In some embodiments the method comprises detecting blur in the processed image data through a blur detection machine learning model and discarding image data of the processed image data based on the detected blur. In some embodiments the method comprises detecting at least a cloud in the processed image data through a cloud detection machine learning model and discarding image data of the processed image data based on the detected clouds. In some embodiments, geolocating the image data comprises utilizing an indirect georeferencing method. In some embodiments, geolocating the image data comprises utilizing Global Positioning System (GPS) coordinates. In some embodiments, the image data is obtained from an imaging device positioned within the stratosphere. In some embodiments, the atmospheric location is an altitude range of about 30,000 feet to about 100,000 feet. In some embodiments, geolocating the image data comprising comprises two or more images of the processed image data to each other.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein

FIG. 1 is a block diagram of an apparatus of high-altitude image processing;

FIG. 2 is a flowchart for a process of image identification;

FIG. 3 is a flowchart of an embodiment of a process of image identification;

FIG. 4 is a flowchart of an embodiment of a process of mosaicking images;

FIG. 5 is an illustration of an embodiment of a graphical user interface;

FIG. 6 is a diagram illustrating an embodiment of a data infrastructure;

FIG. 7 is a flowchart of a method of performing high-altitude image processing;

FIG. 8 is a block diagram of an embodiment of machine learning module; and

FIG. 9 is a block diagram of a computing system that may be used in apparatuses, systems, and methods described herein.

### DETAILED DESCRIPTION

Prior approaches to high-altitude image processing may utilize various techniques for image enhancement, filtering and/or processing. These may include direct georeferencing based on onboard sensors with sub-meter pointing accuracy, use of consistent and predictable vehicle trajectories during the imaging period, simultaneous capture of large scenes by a camera, use of several imaging bands to detect clouds in the infrared spectrum, as well as others. In some cases, human analysts may be used to remove defective imagery, geolocate images, and/or correct mosaic stitching problems. However, these approaches are ill-suited to processing image data described herein. Embodiments of the present disclosure provide for processing of high-altitude imagery without reliance on any of the above described prior approaches and provides for a more direct technique of processing high-altitude imagery.

Embodiments of the present disclosure may allow for the transformation of raw, unprocessed, aerial imagery captured with stratospheric imaging systems to map-ready imaging, consisting of the processes of color-correcting the imagery, detecting blur and cloudy imagery with specially-trained algorithms, and georeferencing the imagery. In some embodiments, apparatuses and methods described herein transform a series of images taken from a stratospheric platform, such as a fixed wing plane, high-altitude balloon or blimp flying between altitudes 30,000 and 100,000 ft, into a location-referenced images corrected for color, and with clouds and other obfuscations and defects eliminated. The transformed imagery may be used for multiple use cases, including but not limited to change detection, disaster planning and response, risk assessment, urbanism, construction, wildlands monitoring, monitoring of infrastructure, and many others.

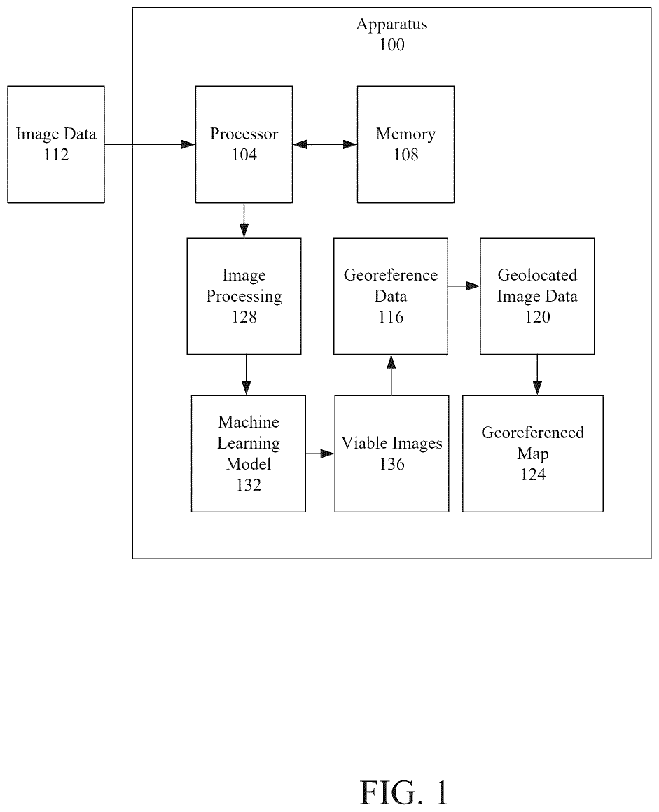

Referring now to FIG. 1, a block diagram of an apparatus 100 for processing high-altitude images is presented. “High-altitude” as used in this disclosure refers to elevations of greater than about 20,000 feet. For instance, high-altitudes may be between about 30,000 feet to about 100,000 feet or greater than about 100,000 feet. Apparatus 100 may include processor 104. Processor 104 may be any form of processor, such as, but not limited to, mobile processors, desktop processors, processors of a server, or other forms of processors. Processor 104 may be communicatively coupled to memory 108. “Communicatively coupled” as used in this disclosure refers to a connection between two objects in which information may be shared. For instance, memory 108 may contain instructions allowing processor 104 to perform various tasks. Memory 108 may be, but is not limited to, random access memory (RAM), dynamic random access memory (DRAM), read-only memory (ROM), solid state drives (SSDs), optical discs, virtual memory, flash memory, or any other form of memory, without limitation. In some embodiments, apparatus 100 may be a computing device. Computing devices may include, but are not limited to, desktops, laptops, tablets, smartphones, servers, or other computing devices. For instance, apparatus 100 may be a cloud-computing device that may be operable to communicate data with a cloud network.

Processor 104 may be configured to obtain image data 112. “Image data” as used in this disclosure refers to information representing a photograph and/or video. For instance and without limitation, image data 112 may include a number of pixels, pixel density, pixel values, red blue green (RGB) values, contrast levels, white balance levels, black balance levels, brightness values, or any other information that may be associated with a photograph and/or video. In some embodiments, image data 112 may be representative of a single photograph. In other embodiments, image data 112 may be a plurality of photographs. Image data 112 may be high-altitude image data. For instance, image data 112 may be of images taken between about 10,000 feet to about 100,000 feet or greater. Image data 112 may be generated by an imaging device. An “imaging device” as used in this disclosure refers to a sensor capable of measuring waves on the electromagnetic spectrum. An imaging device may include, but is not limited to, an image sensor, a camera, or other imaging device. In some embodiments, image data 112 may be generated by an imaging device of an aerial vehicle. An “aerial vehicle” as used in this disclosure refers to an object able to transverse through the Earth's atmosphere or orbit. Aerial vehicles may include, but are not limited to, hot air ballons, weather ballons, unmanned aerial vehicles (UAVs), drones, planes, helicopters, satellites, or other aerial vehicles. In some embodiments, an aerial vehicle may have an imaging device that may produce image data 112. Aerial vehicles may be positioned at high-altitudes, such as altitudes above about 10,000 feet. Image data 112 may include high-altitude images, such as images produced at altitudes of about or greater than about 10,000 feet.

In some embodiments, processor 104 may obtain image data 112 through a wired or wireless connection. Processor 104 may be part of an on-board computing system of an aerial vehicle and may obtain image data 112 directly from an imaging device of the aerial vehicle. In some embodiments, image data 112 may be communicated to processor 104 over a wireless connection, such as, but not limited to, Wi-Fi or cellular networks. Image data 112 may be provided to processor 104 in a first image format, such as a RAW format. Processor 104 may be configured to convert image data 112 in a RAW format to one or more other image formats, such as but not limited to TIFF, JXL, BIN, PNG, JPEG, or other image formats. In some embodiments, image data 112 may be in any image format described herein and processor 104 may convert an image format of image data 112 to any other image format described herein. Processor 104 may be configured to process image data 112 in channels of, but not limited to, 8 bits, 12, bits, 16 bits, or greater than 16 bits. For instance, image data 112 may have an RGB channel of 8 bits, 12 bits, 16 bits, greater than 16 bits, or less than 8 bits. In some embodiments, image data 112 may have an image size. An “image size” as used in this disclosure refers to how many pixels are present in an image. Image data 112 may have an image size of, but not limited to, 1 KB to about 1 GB or greater than about 1 GB. Image data 112 may have a resolution. A “resolution” as used in this disclosure refers to how many pixels are present in both horizontal and vertical dimensions of an image. Image data 112 may have a resolution of about 1 cm to about 50 cm. Image data 112 may have a resolution of about 360p, 720p, 1080p, 1440p, 2160p, or greater than about 2160p. In some embodiments, image data 112 may have a resolution of up to or greater than about 9592×6368.

Processor 104 may be configured to perform image processing 128 on image data 112. “Image processing” as used in this disclosure refers to a method of modifying an image by manipulating, filtering, editing or otherwise changing elements of the image data. Image processing 128 may include, but is not limited to, de-vignetting, balancing of white points, balancing of black points, adjusting contrasts, applying one or more image filters, or other modifications of an image. “De-vignetting” as used in this disclosure refers to the process of removing vignetting of an image. “Vignetting” as used in this disclosure refers to a reduction in an image's brightness and/or saturation towards periphery portions of the image compared to a center of the image. Processor 104 may be configured to de-vignette image data 112 through adjusting brightness and/or saturation values of one or more portions of image data 112. A “white point” as used in this disclosure refers to a one or more values within in image that represent the color white. A “black point” as used in this disclosure refers to one or more values within in image that represent the color black. Processor 104 may be configured to balance one or more white points and/or black points of image data 112. For instance, processor 104 may adjust color values of image data 112 to match white points and/or black points of image data 112 to actual lighting conditions of image data 112. “Contrast” as used in this disclosure refers to a difference between darkest and lightest areas of an image. Processor 104 may be configured to adjust contrast values and/or levels of image data 112. For instance, processor 104 may be configured to utilize sigmoidal contrast adjustment or other forms of contrast adjustment without limitation. An “image filter” as used in this disclosure is a digital technique applied to an image to modify the image's appearance. Filters may include, but are not limited to, smoothing filters, sharpening filters, edge detection filters, nonlinear filters, frequency domain filters, specialized filters, or other forms of filters. Processor 104 may be configured to apply one or more filters to image data 112, which may enhance clarity, sharpness, color representation, or other variables of image data 112 relative to an unprocessed version of image data 112. Image processing 128 may include denoising image data 112. “Denoising” as used in this disclosure refers to the process of removing noise from an image. Denoising may be performed using, but not limited to, Gaussian filtering, median filtering, wavelet transformation, statistical approaches, and/or machine learning. Image processing 128 may include haze correction. “Haze” as used in this disclosure refers to a fuzziness of an image. Haze may be removed by processor 104 through image processing 128. For instance, image processing 128 may include dark object subtraction, atmospheric correction, dark channel prior, contrast limited adaptive histogram equalization, or other techniques.

Image processing 128 may include color correction. “Color correction” as used in this disclosure refers to a process of adjusting color values in an image to improve clarity, visibility, and/or accuracy. Processor 104 may color correct image data 112 through one or more of de-vignetting, white balancing, atmospheric correction, denoising, adjusting red hues, blue hues, and/or green hues, or other forms of color correction. “Atmospheric correction” as used in this disclosure refers to a process of removing scattering and/or absorption effects of an atmosphere on an image. For instance, image data 112 may have scattering and/or absorption effects due to image data 112 being generated at high-altitudes, such as but not limited to about 10,000 feet to about 100,000 feet or greater. Processor 104 may be configured to perform atmospheric correction on image data 112, which may account for any atmospheric disruptions to image data 112. In some embodiments processor 104 may be configured to apply atmospheric correction to image data 112 based on an atmospheric location in which image data 112 may have been generated. An “atmosphere” as used in this disclosure refers to an envelope of gases surrounding the earth. Atmospheres may include, but are not limited to, the troposphere, the stratosphere, the mesosphere, the thermosphere and/or the exosphere. An atmospheric location may be anywhere from about 100 feet to about 100,000 feet or greater. In some embodiments, image processing 128 may be specific to an atmospheric location of an altitude between about 10,000 feet to about 100,000 feet. Based on a type of atmosphere in which image data 112 may have been generated, processor 104 may be configured to apply atmospheric correction specific to the type of atmosphere identified. In some embodiments, a type of atmosphere may be provided as meta data of image data 112. In other embodiments, a type of atmosphere may be provided via user input and/or external computing devices. Image processing 128 may include an order of two or more image processing techniques. For instance and without limitation, image processing 128 may include de-vignetting, then atmospheric correction, then contrast adjustment, then color balancing, then denoising. Any order of any image processing techniques described herein may be utilized, without limitation.

Still referring to FIG. 1, in some embodiments, processor 104 may perform two or more image processing 128 techniques described herein on image data 112. In some embodiments, processor 104 may utilize an image correction machine learning model. An “image correction machine learning model” as used in this disclosure refers to a machine learning model that is trained to input images and output corrected images. An image correction machine learning model may be trained with training data correlating images to corrected images. Training data may be received via user input, external computing devices, and/or previous iterations of processing. An image correction machine learning model may be trained to input image data 112 and output a corrected version of image data 112. A corrected version of image data 112 may be image data 112 that has undergone one or more image processing and/or color correction techniques described herein. An image correction machine learning model may be trained to identify which image processing and/or color correction techniques should be utilized for image data 112 and may carry out the identified image processing and/or color correction techniques. As a non-limiting example, denoising may be applicable to a first image and white point balancing may be applicable to a second image.

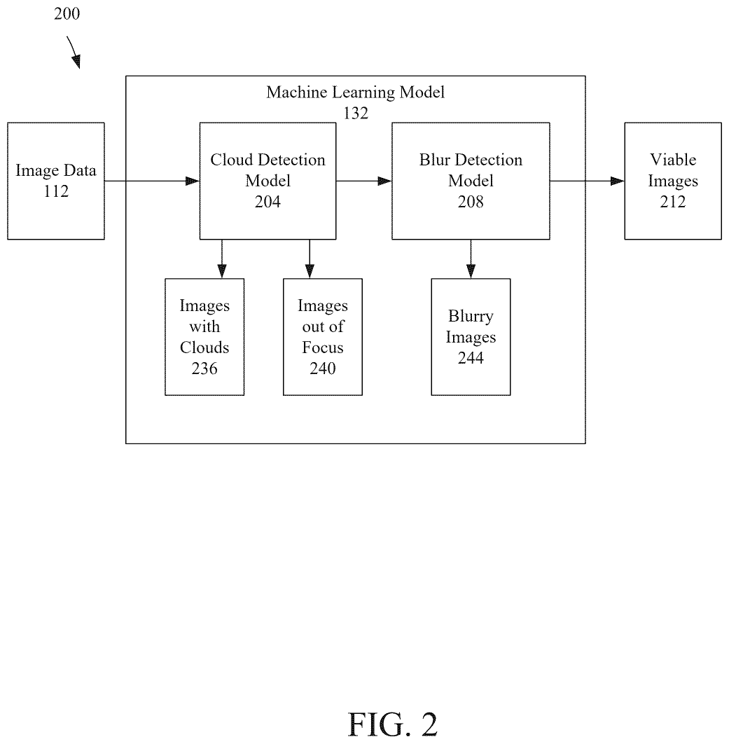

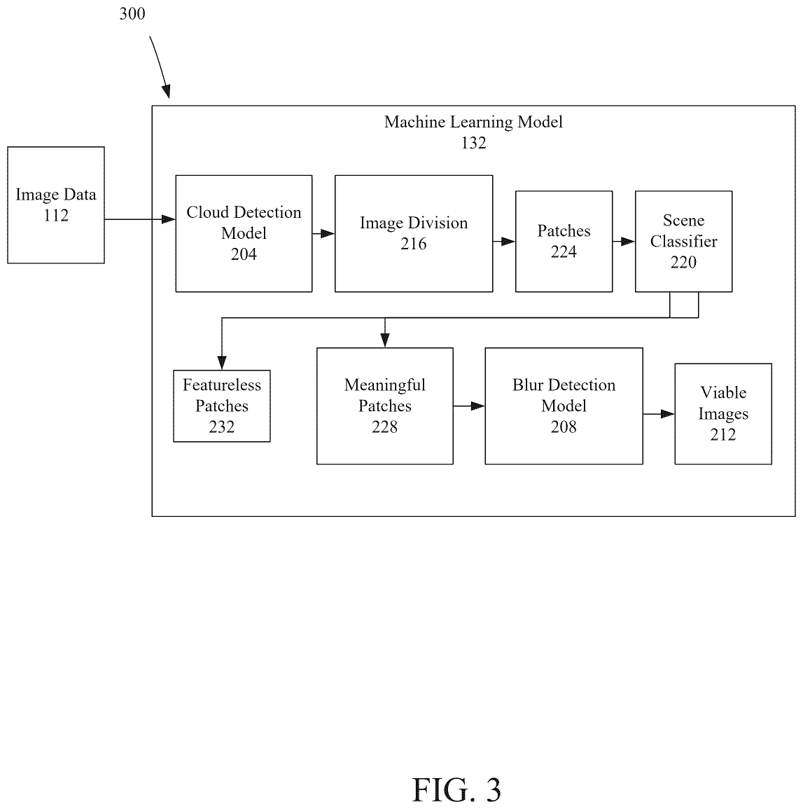

Processor 104 may utilize machine learning model 132. A “machine learning model” as used in this disclosure refers to a computer process capable of learning from training data and/or previous iterations of processing. Machine learning model 132 may be, but is not limited to, a supervised learning model, a semi-supervised learning model, an unsupervised learning model, a reinforcement learning model, a self-supervised learning model, linear regression models, logistic regression models, decision tree models, random forest models, gradient boosting models, support vector machines, K-nearest neighbors models, Naïve Bayes models, neural networks, hidden Markov models, Bayesian networks, or any other form of machine learning model. Machine learning model 132 may be trained to identify obscure images of image data 112. “Obscure images” as used in this disclosure refers to images that are unclear. For instance, obscure images of image data 112 may be images containing clouds, blurred images, images that are out of focus, or other forms of obscure images. Machine learning model 132 may be trained on training data correlating image data 112 to obscure images. Training data may be provided via user input, external computing devices, and/or previous iterations of processing. In some embodiments, machine learning model 132 may be trained to input raw image data 112 that may not have undergone image processing 128. In some embodiments, machine learning model 132 may be trained on processed image data 112 that may have undergone image processing 128. For instance, image processing 128 may produce processed image data. Processed image data may be clearer than unprocessed image data, which may allow machine learning model 132 to more efficiently identify obscure images from image data 112. Machine learning model 132 may include two or more models. Two or more models of machine learning model 132 may be any combination of machine learning models described herein without limitation. Machine learning model 132 is described in more detail below with reference to FIGS. 2-3.

Machine learning model 132 may filter, drop, or remove detected obscure images of image data 112 from further processing. An output of machine learning model 132 may be viable images 136. “Viable images” as used in this disclosure refers to image data that is non-obscured. Viable images 136 may be image data 112 that has been processed by image processing 128 and deemed non-obscured by machine learning model 132. Processor 104 may receive viable images 136 from machine learning model 132. Processor 104 may be configured to compare viable images 136 with georeference data 116. “Georeference data” as used in this disclosure refers to information providing a relative geographical location of an image or object. Georeference data 116 may include, but is not limited to, geographically accurate maps, global positioning system (GPS) coordinates, ground control points, latitudes, longitudes, elevations, or other information that may be utilized to georeference one or more images. Georeference data 116 may be provided to processor 104 through user input and/or external computing devices. In some embodiments, processor 104 may be configured to search for georeference data 116 through one or more databases, including but not limited to the Internet. Processor 104 may compare georeference data 116 to viable images 136 to determine a location of viable images 136, which may generate geolocated image data 120. Geolocated image data” as used in this disclosure refers to image data that is associated with a geolocation. Geolocations may include, but are not limited to, GPS coordinates, ground control points, countries, states, jurisdictions, counties, cities, towns, roads, or any other form of geolocation. For instance and without limitation, processor 104 may compare one or more features of georeference data 116 to one or more features of viable images 136. Features may include, but are not limited to, trees, cities, cars, buildings, roads, deserts, oceans, or other features. In some embodiments, georeference data 116 may include one or more Global Positioning System (GPS) coordinates. Processor 104 may be configured to compare GPS coordinates of georeference data 116 with one or more GPS coordinate of meta data of image data 112 and/or viable images 136. In some embodiments, processor 104 may directly georeference viable images 136 with georeference data 116 to produce geolocated image data 120. For instance, processor 104 may compare GPS coordinates associated with viable images 136 with GPS coordinates of georeference data 136. In some embodiments, processor 104 may utilize image sensor data that may be part of meta data of image data 112. Image sensor data may include, but is not limited to, GPS coordinates, roll values, pitch values, y aw values, focal length values, distortion values, time of capture values, or other image sensor data. Processor 104 may input image sensor data along with image data 112 and may compare image sensor data and/or image data 112 with georeference data 136 to generated geolocated image data 120.

Processor 104 may be configured to compare two or more images of viable images 136 to each other to determine geolocated image data 120. For instance, features of one image of viable images 136 may be compared to features of a second image of viable images 136, which processor 104 may utilize to generate geolocated image data 120 from. In some embodiments, processor 104 may utilize both comparisons of images of viable images 136 to each other and georeference data 116 to generate geolocated image data 120. In other embodiments, processor 104 may be configured to utilize georeference data 116 solely to generate geolocated image data 120.

Processor 104 may be configured to utilize an indirect georeferencing method to geolocate viable images 136. An “indirect georeferencing method” as used in this disclosure refers to a process of georeferencing one or more images without known reference points. An indirect georeferencing method may include utilization of one or more ground control points, which may be known coordinates visible in geolocated image data 120. In some embodiments, an indirect georeferencing method may include warping or transforming geolocated image data 120 so that features of geolocated image data 120 match one or more ground control points. Indirect georeferencing may include utilization of an image sensor's orientation and/or parameters. Indirect georeferencing may include ground control point polynomial warping. For instance, one or more known ground coordinates may be matched to one or more portions of an image of viable images 136. Affine, projective, and/or polynomial transformations may be performed on viable images 136 to generated geolocated image data 120. Indirect georeferencing may include image to image registration. Image to image registration may include detecting and/or comparing one or more features between two or more images of viable images 136. In some embodiments, image to image registration may include homography and/or similarity transforms. An indirect georeferencing method may include bundle adjusting. Processor 104 may be configured to utilize a bundle adjustment to geolocate viable images 136. A “bundle adjustment” as used in this disclosure refers to a process of refining coordinates describing scene geometry. Bundle adjustment may include minimizing a reprojection error between two or more image locations and/or predicted image points. A bundle adjustment may be expressed as a sum of squares of a large number of nonlinear real-valued functions. Minimization in a bundle adjustment process may occur using nonlinear least-squares algorithms. Bundle adjustment may include iteratively adjusting one or more parameters to best fit viable images 136.

In some embodiments, processor 104 may utilize a geolocation machine learning model. A “geolocation machine learning model” as used in this disclosure refers to a machine learning model that is trained to input an image and output a geolocation of the image. A geolocation machine learning model may be trained with training data including images, reference data, and/or example geolocated image outputs. Training data may be received via user input, external computing devices, and/or previous iterations of processing. A geolocation machine learning model may input viable images 136 and georeference data 116 and may output a geolocation of viable images 136. Processor 104 and/or a geolocation machine learning model may output geolocated image data 120.

Referring still to FIG. 1, processor 104 may be configured to mosaic geolocated image data 120 to generate georeferenced map 124. A “georeferenced map” as used in this disclosure refers to a combination of two or more geolocated images. “Mosaic” as used in this disclosure refers to a process of combining two or more images to form a larger image. Processor 104 may be configured to mosaic geolocated image data 120 through combining two or more images of geolocated image data 120 to form a larger geolocated image, which may be part of georeferenced map 124. In some embodiments, processor 104 may perform radiometric correction of one or more geolocated images of geolocated image data 120. Radiometric correction may include color correction or other image processing techniques described herein. Processor 104 may utilize GPS coordinates of geolocated image data 120 to mosaic georeferenced map 124. In other embodiments, processor 104 may utilize one or more indirect georeferencing methods to mosaic georeferenced map 124, which may include using one or more features of an image of geolocated image data 120 as relativistic geolocation points for one or more other images of geolocated image data 120. In some embodiments, two or more images of geolocation image data 120 may overlap. Processor 104 may be configured to identify an overlap between two or more images of geolocated image data 120 and utilize the overlap as a reference point in mosaicking georeferenced map 124. For instance, processor 104 may be configured to combine portions of overlapping images of geolocated image data 120. Processor 104 may perform a feathering, multiresolution blending, histogram matching, or other process on one or more parts of georeferenced map 124, which may improve a continuity between two or more combined images of geolocated image data 120 mosaiced into georeferenced map 124.

Referring now to FIG. 2, a flowchart of an image selection process 200 is presented. Image selection process 200 (also referred to as “process 200”) may utilize image data 112 and machine learning model 132 described above with reference to FIG. 1. Process 200 may include utilization of cloud detection model 204, which may be part of machine learning model 132. A “cloud detection model” as used in this disclosure refers to a specially-trained machine learning model that is trained to identify one or more cloud within one or more images. Cloud detection model 204 may be trained with training data correlating images to clouds. Training data may be received via user input, external computing devices, and/or previous iterations of processing. Cloud detection model 204 may be trained to identify different types of clouds within image data 112, such as, but not limited to, cirrus, cirrostratus, cirrocumulus, altostratus, altocumulus, stratus, stratocumulus, nimbostratus, cumulus, and/or cumulonimbus. Cloud detection model 204 may determine if an image of image data 112 is viable based on a type of cloud identified within the image of image data 112. For instance and without limitation, a small cirrus cloud present in an image of image data 112 may be deemed viable by cloud detection model 204, while a large stratocumulus cloud in an image of image data 112 may be deemed obscured by cloud detection model 204. In some embodiments, cloud detection model 204 may identify a portion of an image of image data 112 covered by one or more clouds. Portions may be percentage values, ratio values, or any other value representative of a portion. For instance, cloud detection model 204 may be trained to identify a percentage from 0% to about 100% of an image of image data 112 that may be covered by one or more clouds. Cloud detection model 204 may utilize a cloud threshold value to identify viable and non-viable images of image data 112. A cloud threshold value may be a percentage value of an amount of clouds covering an image of image data 112. A cloud threshold value may be about 1% to about 50% or greater. In some embodiments, cloud detection model 204 may be trained to identify a travel path of one or more clouds within one or more images of image data 112. Training data may be provided by user input, external computing devices, and/or previous iterations of processing. A travel path may be a projected movement of one or more clouds relative to one or more features of an image of image data 112. A travel path may include a velocity, such as meters per second. In some embodiments, a travel path may include a timeline with predicted time stamps associated with a location of one or more clouds. For instance, a travel path may indicated that in about 1 hour, all clouds in an image of image data 112 may travel out of sight of an image sensor or other imaging device. A projected travel path of one or more clouds of image data 112 may be communicated to a processor or external computing device, which may allow a imaging device or user to capture image data 112 at times when clouds may be absent from a location of an imaging device.

Cloud detection model 204 may include one or more neural networks. For instance, cloud detection model 204 may include two or more nodes of a neural network. In some embodiments, cloud detection model 204 may be a convolutional neural network (CNN) with one or more network layers. Cloud detection model 204 may input image data 112 in sizes of about 200×300 pixels or greater. In some embodiments, image data 112 may be divided into one or more sub images and provided to cloud detection model 120. In other embodiments, entire images of image data 112 may be provided to cloud detection model 120 at a single time. Cloud detection model 204 may input image data 112 and output a classification of image data 112. Classifications may include, but are not limited to, cloudy, out of focus, and/or no cloud. A cloudy classification may be a grouping of image data 112 that has one or more clouds. An out of focus classification may be a grouping of image data 112 that is not in focus relative to an image sensor in which image data 112 may have been generated. A no cloud classification may be a grouping of image data 112 that is absent any clouds and/or not out of focus and may be used for further processing. In some embodiments, an output of cloud detection model 204 may be image data 112 that is in focus and does not have clouds. Image data 112 deemed to be out of focus or have clouds may be classified as images with clouds 236 and images out of focus 240 respectively, and may be discarded from further processing. Cloud detection model 204 may feed directly into blur detection model 208. In some embodiments, cloud detection model 204 is arranged in series with blur detection model 208. In other embodiments, cloud detection model 204 and blur detection model 208 may run in parallel.

A “blur detection model” as used in this disclosure refers to a machine learning model trained to identify amounts of blur in images. Blur detection model 208 may be part of machine learning model 132. For instance, machine learning model 132 may include either or both of cloud detection model 204 and blur detection model 208. In other embodiments, cloud detection model 204 and blur detection model 208 may be standalone models, separate from machine learning model 132. “Blur” as used in this disclosure refers to an obscurement of an image. Blur detection model 208 may be any type of machine learning model described herein. In some embodiments, blur detection model 208 may be a regression model. Blur detection model 208 may be trained to output or predict a blur value for an image of image data 112. Image data 112 input to blur detection model 208 may be about 448×448 pixels or greater. In some embodiments, image data 112 may be divided into one or more sub images. Each sub image generated from image data 112 may be separately input to blur detection model 208. In some embodiments, blur detection model 208 may output a single blur value per image of image data 112. In other embodiments, blur detection model 208 may output two or more blur values per image of image data 112. A “blur value” as used in this disclosure refers to a numerical value representative of an amount of blur in a portion or entirety of an image. A greater blur value may represent a greater amount of blur in an image, while a lesser blur value may represent a lesser amount of blur in an image. A blue value may be any numerical value, such as between 0-1, between 0-10, between 0-100, or other values. A blur value may be interpreted by blur detection model 208 as a blurriness score. A blurriness score may be out of 1, out of 10, out of 100, a percentage value, or other value. Based on a blurriness score, blur detection model 208 may classify image data 112 into one or more categories as described herein. In some embodiments, two or more portions of an image of image data 112 may be blurred. Blur detection model 208 may be trained to aggregate two or more blurred portions of an image into a single blur value. In some embodiments, blur detection model 208 may generate a blur value of a first portion of an image and a second blur value of a second portion of the image. Blur detection model 208 may average two or more blur values of a single image to calculate a final blur value of the image.

Blur detection model 208 may be trained with training data correlating images to blurry images and/or unblurry images. Training data may be received via user input, external computing devices, and/or previous iterations of processing. Blur detection model 208 may be trained to input image data 112 and output classifications of image data 112. Classifications may include, but are not limited to, blurry and not blurry. Image data 112 that may be deemed by blur detection model 208 to be blurry may be discarded as blurry images 244 from future processing. Blurry images 244 may be classified from image data 112 based on a blurriness score of about 5% or higher. For instance, if blur detection model 208 generates a blurriness score for image data 112 that is about 5%, image data 112 may be classified as blurry images 244. Image data 112 that is deemed to not be blurry by blur detection model 208 may be classified as viable images 212, and may be utilized for subsequent processing. In some embodiments, blur detection model 208 may output a quality assurance classification of image data 112. A quality assurance classification may be a grouping of image data 112 that may be slightly blurry but may not be over a blur threshold amount to be classified as blurry images 244. A blur threshold amount for classification to a quality assurance grouping may be a blurring of about 5% or greater of an image of image data 112.

Referring now to FIG. 3, another process 300 of image detection is presented. Process 300 may be the same as process 200 described above with reference to FIG. 2 with the addition of image division 216 and scene classifier 220. In some embodiments, scene classifier 220 may be part of blur detection model 208. For instance, blur detection model 208 may include a first neural network that may be trained to classify images based on detected blur amounts and a second neural network that may be scene classifier 220. In other embodiments, scene classifier 220 may be separate from blur detection model 208.

Image data 112 may be input to cloud detection model 204. Cloud detection model 204 may provide image data 112 that is in focus and absent clouds. Machine learning model 132 may include image division 216. In other embodiments, image division 216 may be separate from machine learning model 132. Image division 216 may be a process that generates one or more patches from one or more images of image data 112. For instance, at image division 216, image data provided by cloud detection model 204 may be broken up into one or more patches 224. A “patch” as used in this disclosure is a sub portion of an image. Patches 224 may be sub portions of entire images and/or sub portions of portions of images. In some embodiments, each patch of patches 224 may have a same resolution and/or size. In other embodiments, two or more patches of patches 224 may have differing resolutions and/or sizes. Image division 216 may randomly divide image data 112 into one or more patches 224. In other embodiments, image division 216 may divide image data 112 into equal patches 224 in a predetermined fashion, such as sizes of about 796×796 or greater, or sizes less than about 796×796. In some embodiments, image division 216 may include dividing a full image of image data 112 into one or more quadrants. A “quadrant” as used in this disclosure refers to a rectangular or square portion of an image. Quadrants of an image of image data 112 may be equal in size. In some embodiments, quadrants of an image of image data 112 may be unequal in size. In some embodiments, image division 216 may include breaking up an image of image data 112 into one or more quadrants. For instance, image data 112 may be broken up into a 3×3 grid, resulting in 9 quadrants, although other sizes of grids may be utilized without limitation. One or more patches 224 may be provided to scene classifier 220. A “scene classifier” as used in this disclosure refers to a machine learning model trained to identify features within an image. Scene classifier 220 may be any machine learning model described herein. In some embodiments, scene classifier 220 is a classification model. Scene classifier 220 may be trained with training data correlating images to one or more scenes. Scenes may include, but are not limited to, forests, parks, buildings, cities, parking lots, roads, lakes, oceans, or any other scene without limitation. Training data may be provided to scene classifier 220 via user input, external computing devices, and/or previous iterations of processing. Scene classifier 220 may be a machine learning model that may be trained to identify meaningful patches 228 from featureless patches 232 based on patches 224. Scene classifier 220 may be trained with training data correlating patches 224 to meaningful patches 228 and/or featureless patches 232. Training data may be received via user input, external computing device, and/or previous iterations of processing. Scene classifier 220 may be trained to input one or more patches 224 and classify the one or more patches 224 as featureless patches 232 or meaningful patches 228. A “featureless patch” as used in this disclosure refers to a patch that is absent any useful geographical features. Featureless patches 232 may be classified based on a set of classes corresponding to useful or non-useful geographical features. For instance, scene classifier 220 may utilize a set of two or more classes, with each class representing a useful geographical feature or non-useful geographical feature. For instance, scene classifier 220 may utilize a set of 10 or more classes, with each class representative of a useful or non-useful geographical feature. Any number of classes may be utilized by scene classifier 220, without limitation. Useful geographical features may include, but are not limited to, roads, buildings, sport courts, rivers, lakes, fields, or any other useful geographical feature. Non-useful geographical features may include, but are not limited to, deserts, large bodies of water, large grass fields, large tree fields, or other features. A “meaningful patch” as used in this disclosure is a patch that has at least one useful geographical feature. Meaningful patches 228 may be provided to blur detection model 208. Blur detection model 208 may remove blurry patches 228 from nonblurry patches 228. Blur detection model 208 may output visible images 212, which may be meaningful patches 228 that are not blurred. By classifying patches 224 into meaningful patches 228, process 300 may optimize classification of viable images 212 by avoiding calculation of blur values of featureless patches 232.

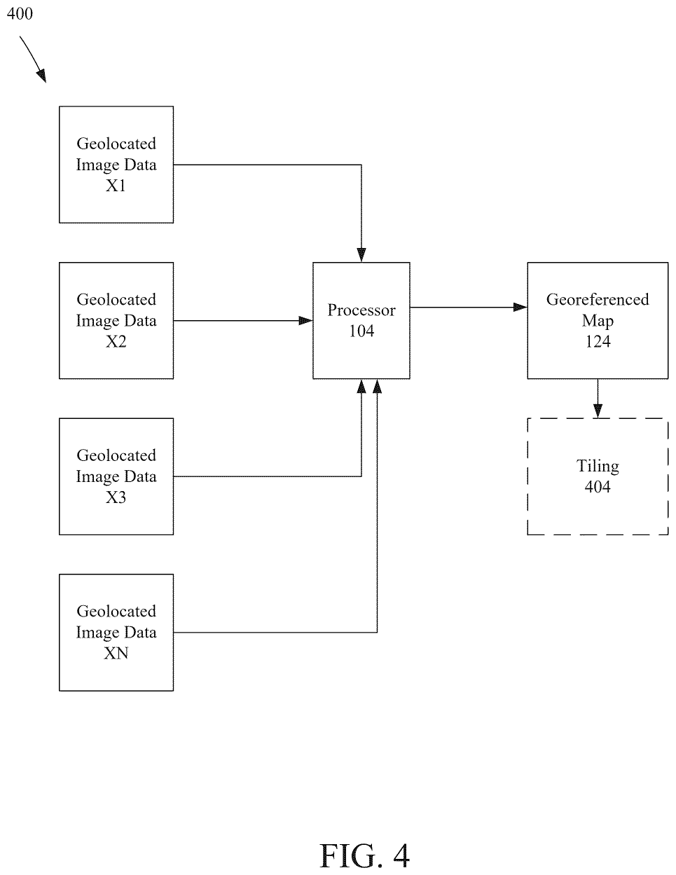

Referring now to FIG. 4, a flowchart of a process 400 for mosaicking a georeferenced map is presented. Process 400 may include processor 104, which may be as described above with reference to FIG. 1. Processor 104 may input geolocated image data, such as geolocated image data 120 described above with reference to FIG. 1.

Processor 104 may input geolocated image data X1 through XN. Each of geolocated image data X1, X2, and X3 may be different images that may have been geolocated by processor 104. Processor 104 may combine each of geolocated image data X1-XN to generate georeferenced map 124. In some embodiments, any or all of geolocated image data X1-XN may have gone through one or more of a cloud detection model, scene classifier, and/or blur detection model. In some embodiments, any or all of geolocated image data X1-XN may have undergone image processing and/or color correction via processor 104. Processor 104 may utilize mosaicking to generate georeferenced map 124 based on geolocated image data X1-XN. Mosaicking may include combining portions of entireties of geolocated image data X1-XN to form a larger image than a size of any of geolocated image data X1-XN. Mosaicking may include georeferencing geolocated image data X1 to any or all of geolocated image data X2-XN. Georeferencing may be direct, such as through the use of GPS coordinates. In other embodiments, georeferencing may be indirect, such as through ground control points, bundle adjustments, or other indirect georeferencing methods. Georeferencing may result in relativistic geolocations of geolocated image data X1 compared to any or all of geolocated image data X2-XN. For instance, geolocated image data X1 may overlap with geolocated image data X2-XN. Overlapping of features between geolocated image data X1-XN may allow processor 104 to combine geolocated image data X1-XN to form georeferenced map 124. Based on georeferencing of geolocated image data X1-XN, processor 104 may be configured to combine one or more portions of geolocated image data X1-XN to form georeferenced map 124. Georeferenced map 124 may be geographically accurate. For instance, georeferenced map 124 may be about 90% or greater in accuracy as a publicly available geographically accurate map.

Processor 104 may be configured to utilize any mosaicking technique, without limitation. For instance, processor 104 may utilize image stitching, which may include combining portions of overlapping geolocated image data X1-XN to form georeferenced map 124. Processor 104 may be configured to georeference geolocated data X1-XN with georeference data, such as GPS coordinates, geographically accurate maps, or other georeference data. Processor 104 may be configured to utilized orthorectified mosaicking. Orthorectified mosaicking may include projecting one or more of geolocated image data X1-XN onto a terrain model to correct distortions from image sensor angles and/or terrains. In some embodiments, processor 104 may be configured to utilize seamline-based mosaicking. Seamline-based mosaicking may include generating optimized boundaries between two or more overlapping images of geolocated image data X1-XN, which may reduce seams between geolocated image data X1-XN. In some embodiments, processor 104 may utilize a mosaicking machine learning model to generate georeferenced map 124. A “mosaicking machine learning model” as used in this disclosure refers to a machine learning model trained to mosaic images. Training data may be received via user input, external computing devices, and/or previous iterations of processing. A mosaicking machine learning model may input geolocated image data X1-XN and output georeferenced map 124.

In some embodiments, processor 104 may be configured to perform tiling 404. “Tiling” as used in this disclosure refers to the process of breaking down an image into smaller tiles. Tiling 404 may include any tiling process, without limitation. Tiling 404 may include fixed grid tiling, slippy map tiling, or other forms of tiling. Tiles produced by tiling 404 may be in formats such as, but not limited to, tif, jpg, png, webp, cog, npy, or other formats. Tiles produced by tiling 404 may be in standardized sizes, such as, but not limited to, 256×256, 512×512, 1029×1024, or any other sizes without limitation. Processor 104 may be configured to breakdown georeferenced map 124 into one or more tiles through tiling 404. Tiles of georeferenced map 124 may be stored in a database. In some embodiments, tiles of georeferenced map 124 may be used for web maps, mobile applications, or other processes without limitation.

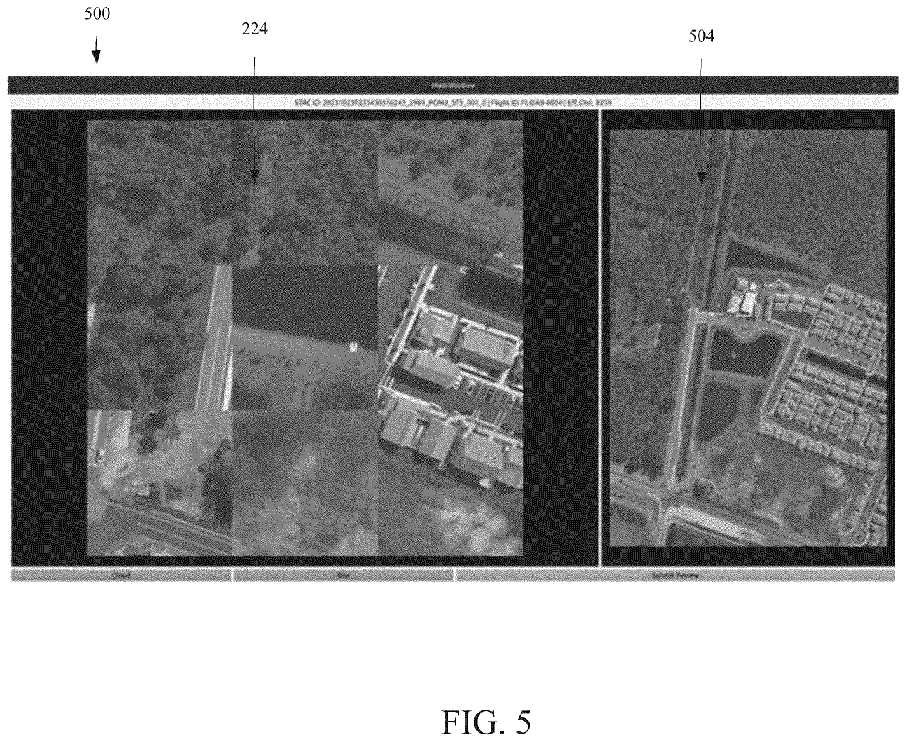

Referring now to FIG. 5, an illustration of a graphical user interface (GUI) 500 is presented. Graphical user interface 500 may present patches 224 and combined image 504. Patches 224 may be as described above with reference to FIG. 3. In some embodiments, patches 224 may each represent a quadrant of a full image, such as combined image 504. Patches 224 may be randomly selected from an image and may be displayed randomly through GUI 500. GUI 500 may be presented when a blur detection model classifies an image to a quality assurance classification. For instance, an image may be slightly blurry, but may not be blurry enough to be classified as a blurry image, which may cause a blur detection model to classify the image to a quality assurance category. An image may be divided into nine or more quadrants. Quadrants of an image may be divided into two or more patches 224. In some embodiments, each patch of patches 224 has an equal size. In other embodiments, each patch of patches 224 has an unequal size. In some embodiments, combined image 504 may be displayed adjacent patches 224, which may allow a reviewer to compare patches 224 and combined image 504 to identify a quality of an image efficiently.

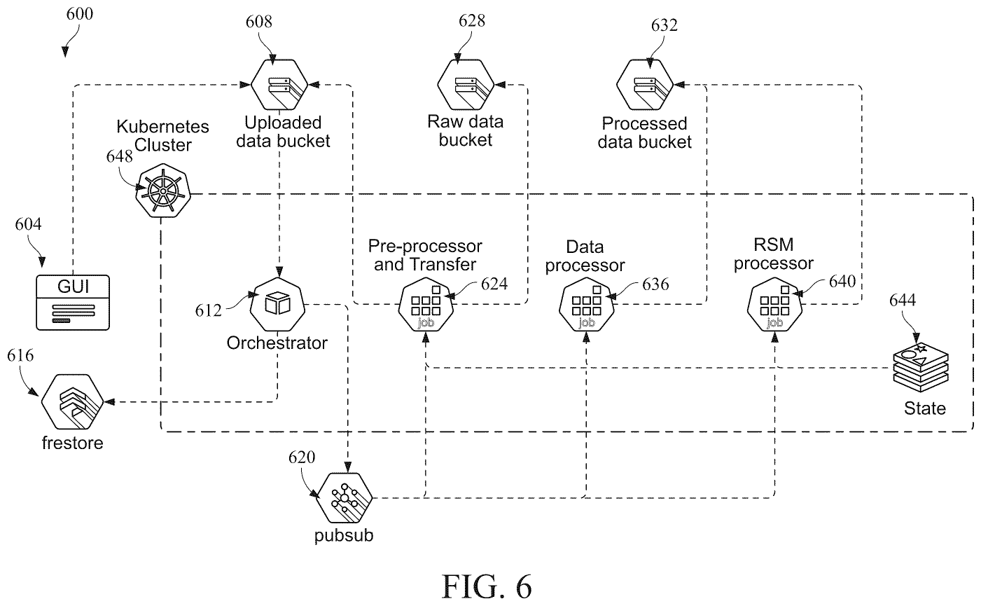

Referring now to FIG. 6, a data pipeline infrastructure 600 is presented. Data pipeline infrastructure 600 (also referred to as “infrastructure 600”) may include graphical user interface (GUI) 604. GUI 604 may allow a user to interact with software of infrastructure 600. Inputs from GUI 604 may be sent to uploaded data bucket 608. Data from uploaded data bucket 608 may be sent to orchestrator 612. Orchestrator 612 may communicate data to data store 616. Data store 616 may act as a database and may store configurations and/or state information about one or more data jobs. Orchestrator 612 may communicate data to command module 620. Command module 620 may be configured to manage and/or trigger events across various components within infrastructure 600. Command module 620 may be configured to trigger one or more stages of processing. For instance, command module 620 may be configured to trigger additional stages of processing once a first stage of processing is identified as being complete. In some embodiments, command module 620 may ensure data processed in one or more data jobs is executed in a correct sequence. Command module 620 may be configured to ensure that data may be moved between components of infrastructure 600 smoothly. Command module 620 may be in communication with pre-process module 624, data processor 636, and/or rational sensor model (RSM) processor 640. Pre-process module 624 may be configured to perform one or more pre-processing steps and/or transfer data to raw data bucket 236. Data processor 636 may be configured to process data and/or communicate processed data to processed data bucket 632. RSM processor 640 may be configured to process sensor data and may provide processed sensor data to processed data bucket 632. State module 644 may be configured to keep track of states of one or more jobs of pre-processor 624, data processor 636, and/or RSM processor 640. Command module 620 may be in communication with state module 644 and may be configured to operate any or all data jobs of pre-processor 624, data processor 636, and/or RSM processor 640. Orchestrator 612, pre-processor 624, data processor 636, RSM processor 640, and/or state module 644 may operate in computing cluster 648. Computing cluster 648 may be a combination of two or more physical and/or virtual computing devices. In some embodiments, computing cluster 648 may be a Kubernetes cluster.

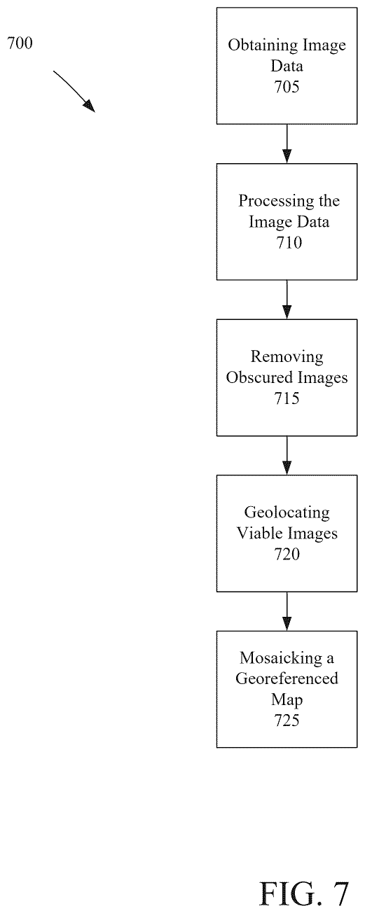

Referring now to FIG. 7, a flowchart 700 of a method of processing high-altitude images is presented. At step 705, method 700 may include obtaining image data. Image data may be obtained from one or more image sensors or other imaging devices. In some embodiments, image data may be obtained from one or more aerial vehicles. Image data may be obtained from an image sensor at altitudes of about 10,000 feet to about 100,000 feet or greater. Image data may include one or more photographs.

At step 710, method 700 may include processing the image data. Processing the image data may include any image processing technique, without limitation. In some embodiments, processing the image data may include color correcting the image data specific to an atmosphere in which the image data was obtained. For instance, image processing may include color correcting the image data specific to, but not limited to, the troposphere, stratosphere, mesosphere, thermosphere, or exosphere. In some embodiments, image processing may include de-vignetting the image data, adjusting white and/or black points in the image data, applying one or more filters to the image data, or any other image processing technique described herein.

At step 715, method 700 includes removing obscured images from the image data. Obscured images may be removed through a machine learning model. In some embodiments, a machine learning model may include a cloud detection model and a blur detection model. A cloud detection model and a blur detection model may operate in series or parallel. In some embodiments, removable of obscured images via a machine learning model may generate viable images.

At step 720, method 700 includes geolocating viable images. Geolocating may include direct or indirect georeferencing methods. In some embodiments, geolocating viable images may include comparing one or more features and/or GPS or ground control points of viable imagery to known GPS and/or ground control points of georeference data. In some embodiments, georeference data may be obtained through searching one or more databases, such as but not limited to the internet. Georeference data may include, but is not limited to, geographically accurate maps, GPS coordinates, landmarks, or other georeference data.

At step 725, method 700 may include mosaicking a georeferenced map. A georeferenced map may be mosaicked through a combination of one or more geolocated viable images. Mosaicking may occur through combining two or more geolocated viable images. In some embodiments, mosaicking may occur through a mosaicking machine learning model. A georeferenced map may as accurate as a publicly available geographically accurate map within a few meters.

Method 700 may be performed without limitation as described above with reference to FIGS. 1-6.

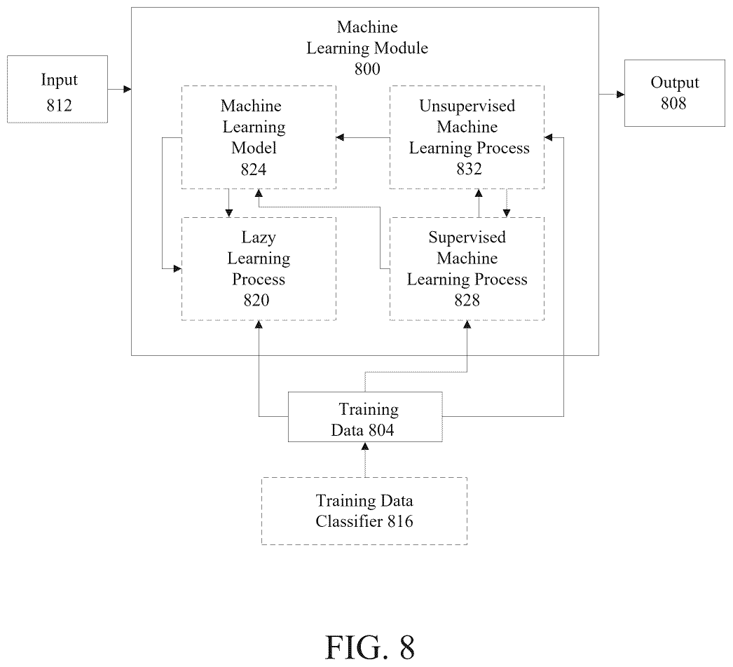

Referring now to FIG. 8, Referring to FIG. 8, an exemplary machine learning module 800 may perform machine learning process(es) and may be configured to perform various determinations, calculations, processes and the like as described herein using one or more machine learning processes.

Machine learning module 800 may utilize training data 804. For instance, and without limitation, training data 804 may include a plurality of data entries, each entry representing a set of data elements that were recorded, received, and/or generated together. Training data 804 may include data elements that may be correlated by shared existence in a given data entry, by proximity in a given data entry, or the like. Multiple data entries in training data 804 may demonstrate one or more trends in correlations between categories of data elements. For instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 804 according to various correlations. Correlations may indicate causative and/or predictive links between categories of data elements, which may be modeled as relationships such as mathematical relationships by machine learning processes as described in further detail below. Training data 804 may be formatted and/or organized by categories of data elements. Training data 804 may, for instance, be organized by associating data elements with one or more descriptors corresponding to categories of data elements. As a non-limiting example, training data 804 may include data entered in standardized forms by one or more individuals, such that entry of a given data element in a given field in a form may be mapped to one or more descriptors of categories. Elements in training data 804 may be linked to descriptors of categories by tags, tokens, or other data elements. Training data 804 may be provided in fixed-length formats, images, videos, formats linking positions of data to categories such as comma-separated value (CSV) formats and/or self-describing formats. Self-describing formats may include, without limitation, extensible markup language (XML), JavaScript Object Notation (JSON), or the like, which may enable processes or devices to detect categories of data.

With continued reference to refer to FIG. 8, training data 804 may include one or more elements that are not categorized. Uncategorized data of training data 804 may include data that may not be formatted or containing descriptors for some elements of data. In some embodiments, machine learning algorithms and/or other processes may sort training data 804 according to one or more categorizations. Machine learning algorithms may sort training data 804 using, for instance, natural language processing algorithms, tokenization, detection of correlated values in raw data and the like. In some embodiments, categories of training data 804 may be generated using correlation and/or other processing algorithms. The ability to categorize data entries in an automated fashion may enable the same training data 804 to be made applicable for two or more distinct machine learning algorithms as described in further detail below. Training data 804 used by machine learning module 800 may correlate any input data as described in this disclosure to any output data as described in this disclosure, without limitation.

Further referring to FIG. 8, training data 804 may be filtered, sorted, and/or selected using one or more supervised and/or unsupervised machine learning processes and/or models as described in further detail below. In some embodiments, training data 804 may be classified using training data classifier 816. Training data classifier 816 may include a classifier. A “classifier” as used in this disclosure is a machine-learning model that sorts inputs into one or more categories. Training data classifier 816 may utilize a mathematical model, an artificial neural network, or a program generated by a machine learning algorithm. A machine learning algorithm of training data classifier 816 may include a classification algorithm. A “classification algorithm” as used herein is one or more computer processes that generate a classifier from training data. A classification algorithm may sort inputs into categories and/or bins of data. A classification algorithm may output categories of data and/or labels associated with the data. A classifier may be configured to output a datum that labels or otherwise identifies a set of data that may be clustered together. Machine learning module 800 may generate a classifier, such as training data classifier 816 using a classification algorithm. Classification may be performed using, without limitation, linear classifiers such as without limitation logistic regression and/or naive Bayes classifiers, nearest neighbor classifiers such ask-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 816 may classify elements of training data to one or more types of scenes and/or useful geographical features.

Still referring to FIG. 8, machine learning module 800 may be configured to perform a lazy-learning process 820 which may include a “lazy loading” or “call-when-needed” process and/or protocol. A “lazy-learning process” may include a process in which machine learning is performed upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 804. Heuristic may include selecting some number of highest-ranking associations and/or training data 804 elements. Lazy learning may implement any suitable lazy learning algorithm, including without limitation a K-nearest neighbors algorithm, a lazy naive Bayes algorithm, or the like. Persons skilled in the art, upon reviewing the entirety of this disclosure, will be aware of various lazy-learning algorithms that may be applied to generate outputs as described herein, including lazy learning applications of machine-learning algorithms as described in further detail below.

Still referring to FIG. 8, machine learning processes as described herein may be used to generate machine learning models 824. An input may be sent to machine learning model 824, which once created, may generate an output as a function of a relationship that was derived. For instance, and without limitation, a linear regression model, generated using a linear regression algorithm, may compute a linear combination of input data using coefficients derived during machine learning processes to calculate an output. As a further non-limiting example, machine learning model 824 may be generated by creating an artificial neural network, such as a convolutional neural network comprising an input layer of nodes, one or more intermediate layers, and an output layer of nodes. Connections between nodes may be created via the process of “training” the network, in which elements from a training data 804 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes.

Still referring to FIG. 8, machine learning algorithms may include supervised machine learning process 828. A “supervised machine learning process” as used herein is one or more algorithms that receive labelled input data and generate outputs according to the labelled input data. For instance, supervised machine learning process 828 may include image data as described above as inputs, obscure images as outputs, and a scoring function representing a desired form of relationship to be detected between inputs and outputs. A scoring function may maximize a probability that a given input and/or combination of elements inputs is associated with a given output to minimize a probability that a given input is not associated with a given output. A scoring function may be expressed as a risk function representing an “expected loss” of an algorithm relating inputs to outputs, where loss is computed as an error function representing a degree to which a prediction generated by the relation is incorrect when compared to a given input-output pair provided in training data 804. Persons skilled in the art, upon reviewing the entirety of this disclosure, will be aware of various possible variations of at least a supervised machine learning process 828 that may be used to determine relation between inputs and outputs. Supervised machine learning processes may include classification algorithms as described herein.

Further referring to FIG. 8, machine learning processes may include unsupervised machine learning processes 832. An “unsupervised machine learning process” as used herein is a process that calculates relationships in one or more datasets without labelled training data. Unsupervised machine learning process 832 may be free to discover any structure, relationship, and/or correlation provided in training data 804. Unsupervised machine learning process 832 may not require a response variable. Unsupervised machine learning process 832 may calculate patterns, inferences, correlations, and the like between two or more variables of training data 804. In some embodiments, unsupervised machine learning process 832 may determine a degree of correlation between two or more elements of training data 804.

Still referring to FIG. 8, machine learning module 800 may be designed and configured to create a machine learning model 824 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of I divided by double the number of samples. Linear regression models may include a multi-task lasso model wherein the norm applied in the least-squares term of the lasso model is the Frobenius norm amounting to the square root of the sum of squares of all terms. Linear regression models may include the clastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model. Linear regression models may be generalized in an embodiment to polynomial regression models, whereby a polynomial equation (e.g. a quadratic, cubic or higher-order equation) providing a best predicted output/actual output fit is sought. Similar methods to those described above may be applied to minimize error functions, according to some embodiments. In some embodiments, machine learning model 824 may utilize one or more encoders and/or decoders, transformer architectures, attention mechanisms, self-attention mechanisms, multi-head attention, masked multi-head attention, token biasing, probability biasing, feed forward layers, positional encoding, recurrent decoders, or any other processes that may be implemented.

Continuing to refer to FIG. 8, machine learning algorithms may include, without limitation, linear discriminant analysis. Machine learning algorithm may include quadratic discriminate analysis. Machine learning algorithms may include kernel ridge regression. Machine learning algorithms may include support vector machines, including without limitation support vector classification-based regression processes. Machine learning algorithms may include stochastic gradient descent algorithms, including classification and regression algorithms based on stochastic gradient descent. Machine learning algorithms may include nearest neighbors algorithms. Machine learning algorithms may include various forms of latent space regularization such as variational regularization. Machine learning algorithms may include Gaussian processes, such as Gaussian Process Regression. Machine learning algorithms may include cross-decomposition algorithms, including partial least squares and/or canonical correlation analysis. Machine learning algorithms may include naive Bayes methods. Machine learning algorithms may include algorithms based on decision trees, such as decision tree classification or regression algorithms. Machine learning algorithms may include ensemble methods such as bagging meta-estimator, forest of randomized tress, AdaBoost, gradient tree boosting, and/or voting classifier methods. Machine learning algorithms may include neural net algorithms, including convolutional neural net processes.

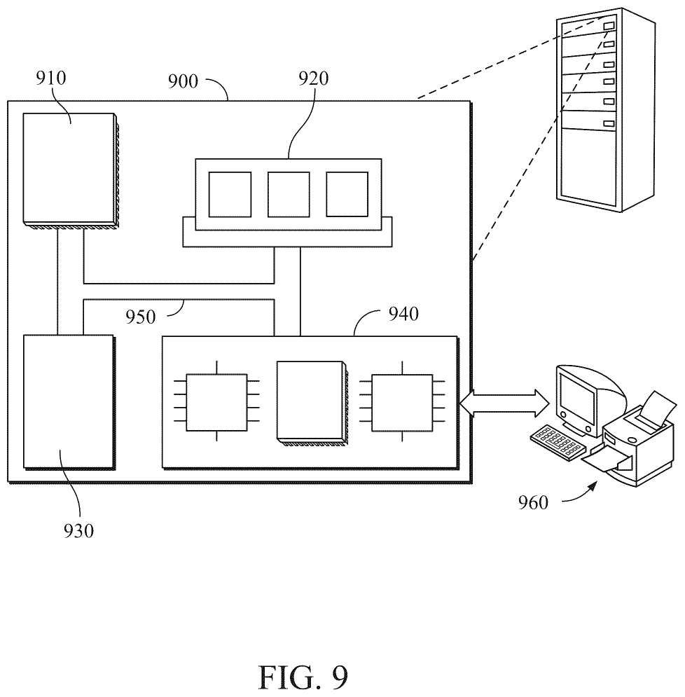

Referring now to FIG. 9 is a block diagram of an example computer system 900 that may be used in implementing the technology described in this document. General-purpose computers, network appliances, mobile devices, or other electronic systems may also include at least portions of the system 900. The system 900 includes a processor 910, a memory 920, a storage device 930, and an input/output device 940. The apparatus may include disk storage and/or internal memory, each of which may be communicatively connected to each other. The apparatus 100 may include a processor 910. The processor 910 may enable both generic operating system (OS) functionality and/or application operations. In some embodiments, the processor 910 and the memory 920 may be communicatively connected. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of a computing device.

Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure. In some embodiments, the processor 910 may include any computing device as described in this disclosure, including without limitation a microcontroller, microprocessor, digital signal processor (DSP) and/or system on a chip (SoC) as described in this disclosure. The processor 910 may include, be included in, and/or communicate with a mobile device such as a mobile telephone or smartphone. The processor 910 may include a single computing device operating independently, or may include two or more computing device operating in concert, in parallel, sequentially or the like. Two or more computing devices may be included together in a single computing device or in two or more computing devices. The processor 910 may interface or communicate with one or more additional devices as described below in further detail via a network interface device. Network interface device may be utilized for connecting the processor 910 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device.

The processor 910 may include but is not limited to, for example, a computing device or cluster of computing devices in a first location and a second computing device or cluster of computing devices in a second location. The processor 910 may include one or more computing devices dedicated to data storage, security, distribution of traffic for load balancing, and the like. The processor 910 may distribute one or more computing tasks as described below across a plurality of computing devices, which may operate in parallel, in series, redundantly, or in any other manner used for distribution of tasks or memory between computing devices. The processor 910 may be implemented using a “shared nothing” architecture in which data is cached at the worker, in an embodiment, this may enable scalability of system 900 and/or processor 910.

With continued reference to FIG. 9, processor 910 and/or a computing device may be designed and/or configured by memory 920 to perform any method, method step, or sequence of method steps in any embodiment described in this disclosure, in any order and with any degree of repetition. For instance, the processor 910 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. The processor 910 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Each of the components 910, 920, 930, and 940 may be interconnected, for example, using a system bus 950. The processor 910 is capable of processing instructions for execution within the system 900. In some implementations, the processor 910 is a single-threaded processor. In some implementations, the processor 910 is a multi-threaded processor. In some implementations, the processor 910 is a programmable (or reprogrammable) general purpose microprocessor or microcontroller. The processor 910 is capable of processing instructions stored in the memory 920 or on the storage device 930.

The memory 920 stores information within the system 900. In some implementations, the memory 920 is a non-transitory computer-readable medium. In some implementations, the memory 920 is a volatile memory unit. In some implementations, the memory 920 is a non-volatile memory unit.

The storage device 930 is capable of providing mass storage for the system 900. In some implementations, the storage device 930 is a non-transitory computer-readable medium. In various different implementations, the storage device 930 may include, for example, a hard disk device, an optical disk device, a solid-date drive, a flash drive, or some other large capacity storage device. For example, the storage device may store long-term data (e.g., database data, file system data, etc.). The input/output device 940 provides input/output operations for the system 900. In some implementations, the input/output device 940 may include one or more network interface devices, e.g., an Ethernet card, a serial communication device, e.g., an RS-232 port, and/or a wireless interface device, e.g., an 802.11 card, a 3G wireless modem, or a 4G/5G wireless modem. In some implementations, the input/output device may include driver devices configured to receive input data and send output data to other input/output devices, e.g., keyboard, printer and display devices 960. In some examples, mobile computing devices, mobile communication devices, and other devices may be used.

1. An apparatus for processing high-altitude images, comprising:
a processor; and
a memory communicatively coupled to the processor, the memory containing instructions configuring the processor to:
obtain high-altitude image data;
perform image processing on the image data specific to an atmospheric location associated with the image data;
remove, through application of a machine learning model, obscure image data from the processed image data to generate viable images;
geolocate the viable images based on obtained georeference data to generate geolocated image data; and
mosaic the geolocated image data to produce a georeferenced map.

2. The apparatus of claim 1, wherein the image processing includes color correction.

3. The apparatus of claim 1, wherein the obscure image data includes images with an amount of blur and the processor is further configured to:
detect blur in the processed image data through application of the machine learning model; and
discard the detected blurred image data from further processing.

4. The apparatus of claim 1, wherein the obscure image data includes images with a cloud and the processor is configured to:
detect clouds in the processed image data through the machine learning model; and
discard image data of the processed image data based on the detected clouds from further processing.

5. The apparatus of claim 1, wherein the processor is configured to geolocate the image data through an indirect georeferencing method.

6. The apparatus of claim 1, wherein the processor is configured to geolocate the image data through global positioning system (GPS) coordinates.

7. The apparatus of claim 1, wherein the image data is obtained from an imaging device positioned within the stratosphere.

8. The apparatus of claim 1, wherein the atmospheric location is an altitude range of about 30,000 feet to about 100,000 feet.

9. The apparatus of claim 1, wherein the processor is further configured to geolocate the image data through comparison of two or more viable images to each other.

10. The apparatus of claim 1, wherein the processor is further configured to mosaic the geolocated image data by combining at least two overlapping images of the geolocated image data.

11. A computer-implemented method of processing high-altitude images, comprising:
obtaining high-altitude image data;
performing image processing on the image data specific to an atmospheric location associated with the image data;
removing, through application of a machine learning model, obscure image data from the processed image data to generate viable images;
geolocating the viable images based on obtained georeference data to generate geolocated image data; and
mosaicking the geolocated image data to produce a georeferenced map.

12. The method of claim 11, wherein the imaging process comprises color correcting the image data.

13. The method of claim 11, further comprising:
detecting blur in the processed image data through a blur detection machine learning model; and
discarding image data of the processed image data based on the detected blur.

14. The method of claim 11, further comprising:
detecting at least a cloud in the processed image data through a cloud detection machine learning model; and
discarding image data of the processed image data based on the detected clouds.

15. The method of claim 11, wherein geolocating the image data comprising utilizing an indirect georeferencing method.

16. The method of claim 11, wherein geolocating the image data comprising utilizing Global Positioning System (GPS) coordinates.

17. The method of claim 11, wherein the image data is obtained from an imaging device positioned within the stratosphere.

18. The method of claim 11, wherein the atmospheric location is an altitude range of about 30,000 feet to about 100,000 feet.

19. The method of claim 11, wherein geolocating the image data comprising comparing two or more images of the processed image data to each other.

20. A non-transitory computer readable medium containing instructions that, when executed by a processor, cause the processor to perform the steps of:
obtaining high-altitude image data;
performing image processing on the image data specific to an atmospheric location associated with the image data;
removing, through application of a machine learning model, obscure image data from the processed image data to generate viable images;
geolocating the viable images based on obtained georeference data to generate geolocated image data; and
mosaicking the geolocated image data to produce a georeferenced map.
